(19) United States
(12) Patent Application Publication
(10) Pub. No.: US 2025/0338366 A1
(43) Pub. Date: Oct. 30, 2025

(54) COOKING APPLIANCE

(71) Applicant: SAMSUNG ELECTRONICS CO., LTD., Suwon-si (KR)

(72) Inventors: Sangwon YUN, Suwon-si (KR); Seokang KIM, Suwon-si (KR); Sooncheol KWEON, Suwon-si (KR); Chulwoo LEE, Suwon-si (KR)

(73) Assignee: SAMSUNG ELECTRONICS CO., LTD., Suwon-si (KR)

(21) Appl. No.: 19/196,333

(22) Filed: May 1, 2025

Related U.S. Application Data
(63) Continuation of application No. PCT/KR2025/004891, filed on Apr. 10, 2025.

(30) Foreign Application Priority Data
Apr. 25, 2024 (KR) 10-2024-0055726

(51) Int. Cl. H05B 6/64

(52) U.S. Cl. CPC H05B 6/645; H05B 6/6423

(57) ABSTRACT

A cooking apparatus may include a cabinet, a chamber inside the cabinet and in which a food to be heated is placeable, the chamber including a sensor hole, a temperature sensor outside the chamber and configured to detect a temperature of the food placed inside the chamber, the temperature sensor including: a detection part configured to detect information about the food through the sensor hole, and a processing part configured to perform processing based on the information detected by the detection part, a blower unit configured to draw in air from outside the chamber, the blower unit including: a first flow path along which a portion of the drawn-in air is flowable to the processing part, and a second flow path along which another portion of the drawn-in air is flowable between the sensor hole and the food to prevent water vapor generated from the food to be cooked from entering the sensor hole.

### CROSS-REFERENCE TO RELATED APPLICATIONS

This is a continuation application, under 35 U.S.C. § 111 (a), of International Application No. PCT/KR2025/004891, filed Apr. 10, 2025, which claims priority under 35 U.S.C. § 119 to Korean Patent Application No. 10-2024-0055726, filed Apr. 25, 2024, in the Korean Intellectual Property Office, the disclosures of which are incorporated herein in their entireties by reference.

### TECHNICAL FIELD

The disclosure relates to a cooking apparatus, and more particularly to a cooking apparatus having an improved structure for measuring the temperature of a food to be cooked.

### BACKGROUND ART

A microwave oven is a kitchen appliance that uses high-frequency waves to simultaneously heat and cook food from the inside and outside of the food. Microwave ovens have high thermal efficiency, which may significantly reduce the cooking time of food and reduce the loss of nutrients during the cooking, defrosting, and reheating process of food. Microwave ovens are also widely used for their advantages, such as the ability to cook food directly from containers.

Microwave ovens are provided for user to operate the microwave oven by setting a predetermined operating time, and it is difficult to determine the degree of cooking of the food during operation, so the cooking state of the food may be checked after the predetermined time is over. Since the food may be overcooked or undercooked after the predetermined time, it is necessary to adjust the operating time of the microwave oven according to the temperature of the food while the microwave oven is operating.

### SUMMARY

An embodiment of the present disclosure provides a cooking apparatus capable of measuring a temperature of a food to be cooked during cooking.

A cooking apparatus according to an embodiment of the present disclosure may efficiently remove moisture remaining between a temperature sensor measuring a temperature of a food to be cooked in a cooking chamber of the cooking apparatus and the food to be cooked, thereby efficiently measuring the temperature of the food to be cooked during cooking.

Technical tasks to be achieved in this document are not limited to the technical tasks mentioned above, and other technical tasks not mentioned will be clearly understood by those skilled in the art from the description below.

In accordance with the present disclosure, a cooking apparatus may include: a cabinet; a cooking chamber inside the cabinet and in which a food to be heated is placeable, wherein the cooking chamber includes a sensor hole; a temperature sensor outside the cooking chamber and configured to detect, through the sensor hole, a temperature of the food placed inside the cooking chamber, wherein the temperature sensor includes: a detection part configured to detect information about the food through the sensor hole, and a processing part configured to perform processing based on the information detected by the detection part; and a blower unit configured to draw in air from outside the cooking chamber, wherein the blower unit includes: a first flow path along which a first portion of the drawn-in air is flowable to the processing part to remove heat generated by the processing part from the processing part, and a second flow path along which a second portion of the drawn-in air is flowable between the sensor hole and the food placed inside the cooking chamber so that, with the food placed inside the cooking chamber being heated and the second portion of the drawn-in air being flowed along the second flow path, the second portion of the drawn-in air prevents water vapor generated from the food to be cooked from entering the sensor hole.

The temperature sensor may be in an outer upper space of the cooking chamber, the sensor hole may be through an upper surface of the cooking chamber, and the blower unit may be further configured so that, with the second portion of the drawn-in air being flowed along the second flow path, the second portion of the drawn-in air passes through a lower end of the sensor hole.

The blower unit may further include: a blower fan configured to draw in the air, and a duct through which the air drawn in by the blower fan may be flowable and which forms the first flow path and the second flow path, and the duct may include: an inlet configured to allow the air from outside the cooking chamber to be drawn in by the blower fan, an inflow path having one end connected to the inlet and configured to allow the drawn-in air to flow therealong, and a partition at an other end of the inflow path and configured to divide the other end of the inflow path into the first flow path and the second flow path.

The blower fan may be on the inflow path, the first flow path may be connected from the inflow path to the outer upper space of the cooking chamber, and the second flow path may be below the first flow path and connected to an inside of the cooking chamber.

The blower fan may be a centrifugal fan having a rotation shaft extending in a vertical direction, the inflow path may be configured so that, with the air from outside the cooking chamber being drawn in, the drawn-in air may be introduced to the centrifugal fan from an upper side of the centrifugal fan, and the first flow path and the second flow path may each extend in a radial direction of the blower fan.

The blower unit may further include a third flow path along which a third portion of the drawn-in air may be flowable toward the cooking chamber so that, with the food placed inside the cooking chamber and the third portion of the drawn-in air being flowed along the third flow path, the third portion of the drain-in air flows toward the food.

The cooking apparatus may further include: a circulation unit configured to draw in air from inside the cooking chamber and to flow the air drawn-in from inside the cooking chamber back to inside the cooking chamber.

The circulation unit may include: a circulation fan configured to draw in the air from inside the cooking chamber, a circulation inlet configured to allow the air from inside the cooking chamber to be drawn in by the circulation fan, a circulation outlet configured to allow the air drawn in by the circulation fan to flow back to inside the cooking chamber, and a circulation duct configured to allow the air drawn in from the circulation inlet to flow to the circulation outlet.

The circulation outlet may be closer to the sensor hole than the circulation inlet.

The cooking apparatus may further include: hood fan configured to draw in air from a lower outer side of the cabinet.

The blower unit, the temperature sensor, and the hood fan may be in an outer upper space of the cooking chamber.

The cooking apparatus may further include: a circulation unit in the outer upper space of the cooking chamber, wherein the circulation unit may be configured to draw in air from inside the cooking chamber and to flow the air drawn-in from inside the cooking chamber back to inside the cooking chamber.

The detection part may include a thermal imaging camera.

The blower unit may further include: a mounting portion on which a sensing unit may be mounted, and a cover bracket on one side of the mounting portion and covering at least a portion of the sensing unit.

The circulation unit may further include: a circulation fan cover covering the circulation fan, and a cover flange extending from one side of the circulation fan cover.

### DESCRIPTION OF DRAWINGS

FIG. 1 is a view illustrating a microwave oven in an installed state, according to an embodiment of the present disclosure.

FIG. 2 is an exploded view of the microwave oven shown in FIG. 1.

FIG. 3 is an exploded view of some configurations of the microwave oven shown in FIG. 1.

FIG. 4 is a view illustrating a temperature sensor and a blower unit of the microwave oven shown in FIG. 1.

FIG. 5 is an exploded view of the temperature sensor and the blower unit of the microwave oven shown in FIG. 1.

FIG. 6 is a cross-sectional view of the temperature sensor and the blower unit of the microwave oven shown in FIG. 1.

FIG. 7 is a view illustrating a circulation unit of the microwave oven shown in FIG. 1.

FIG. 8 is an exploded view of the circulation unit of the microwave oven of FIG. 1.

FIG. 9 is a cross-sectional view of the circulation unit of the microwave oven shown in FIG. 1.

FIG. 10 is a schematic view illustrating air circulation within a cabinet of the microwave oven shown in FIG. 1.

FIG. 11 is a cross-sectional view illustrating a temperature sensor and a blower unit of a microwave oven according to an embodiment.

### DETAILED DESCRIPTION OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

Hereinafter, various embodiments according to the present disclosure will be described in detail below with reference to the accompanying drawings.

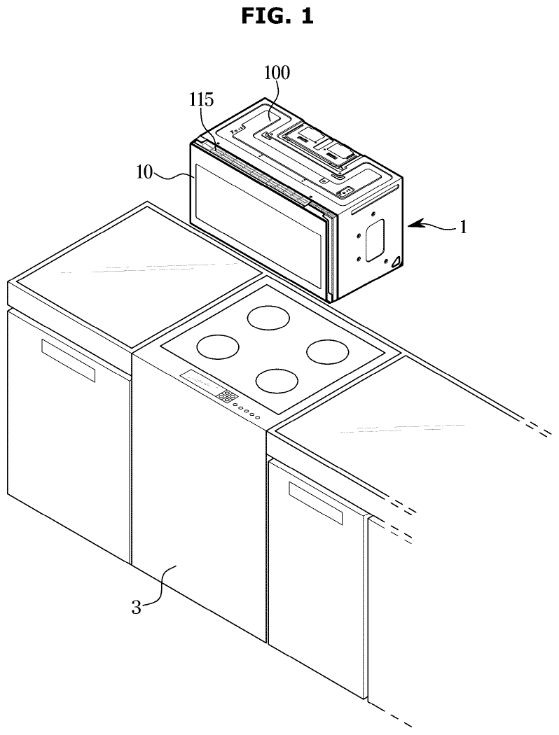

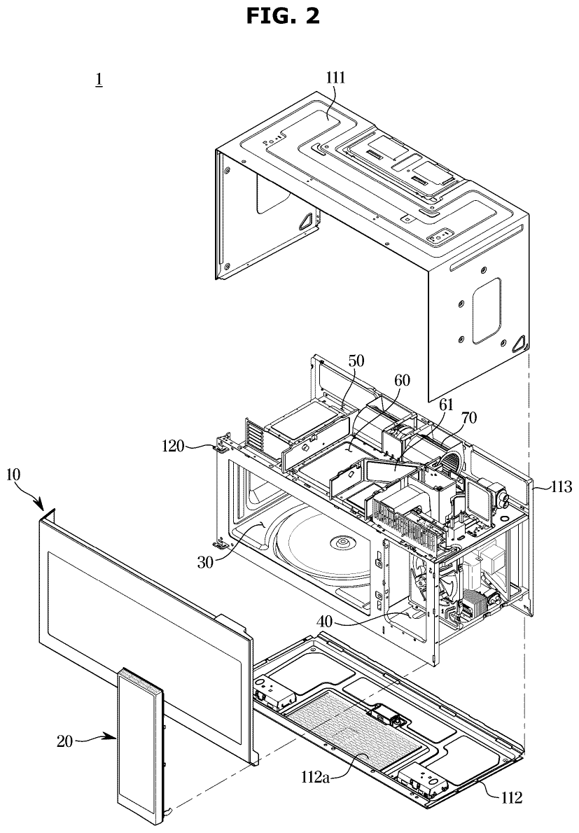

FIG. 1 is a view illustrating a microwave oven in an installed state, according to an embodiment of the present disclosure. FIG. 2 is an exploded view of the microwave oven shown in FIG. 1.

In an example, the following description will be given of a microwave oven 1 with a hood among cooking apparatuses, but is not limited thereto and may also be applicable to conventional microwave ovens 1 without a hood function.

Referring to FIGS. 1 and 2, the microwave oven 1 may be installed on top of another cooking apparatus 3. Such a microwave oven 1 may be referred to as a wall-mounted microwave oven or over-the-range (OTR) microwave oven because it is mounted on a wall to perform the hood function. Hereinafter, the microwave oven 1 may refer to an OTR microwave oven as a microwave oven 1. However, the present is not limited thereto, and the microwave oven 1 described herein may also be applied to a microwave oven that does not have a hood function and may be installed in various ways, such as without being mounted on top or on a wall of another cooking apparatus 3.

The microwave oven 1 may include a cabinet 100 that forms an exterior thereof. The cabinet 100 may also be defined as a main body of the microwave oven 1.

The cabinet 100 may be positioned on an upper portion of the cooking apparatus 3, and may be fixedly coupled to a wall at a rear surface. However, the present disclosure is not limited thereto, and a side surface of the cabinet 100 or an upper surface of the cabinet may be fixedly coupled to a wall. In addition, depending on the user's choice, the microwave oven 1 may be coupled to the wall and used as a wall-mounted microwave oven, or it may be used while placed on the installation surface.

The cabinet 100 may include a cabinet cover 111 that forms an upper surface and both side surfaces of the cabinet 100, and a hood plate 112 that forms a lower surface of the cabinet 100 and has a cabinet inlet 112a formed to allow exhaust gases generated by the cooking apparatus 3 to flow in. The cabinet 100 may include a frame 120 that forms the skeleton of the cabinet 100 and divides a cooking chamber 30, an electrical chamber 40, and an upper space 50, which will be described below.

The cabinet 100 may include a rear plate 113 forming a rear surface of the cabinet 100. The cabinet cover 111, the hood plate 112, the frame 120, and the rear plate 113 may be provided separately, or any or all of them may be provided integrally.

The microwave oven 1 may include the cooking chamber 30 having an open front for inserting food therein, and the electrical chamber 40 formed on an outer side of the cooking chamber 30 and in which various electrical compartments are installed.

The microwave oven 1 may include the upper space 50 formed on an outer upper side of the cooking chamber 30 and in which a blower unit 200 (e.g., a blower), a circulation unit 400 (e.g., a circulator), and a hood fan 70, which will be described below, are arranged

The cooking chamber 30, the electrical chamber 40, and the upper space 50 may each be partitioned by the frame 120. More particularly, the exterior of the microwave oven 1 may be formed by the cabinet cover 111, the hood plate 112, at least a portion of the frame 120, and the rear plate 113, and the cooking chamber 30, the electrical chamber 50, and the upper space 50 may be formed within the exterior.

A door 10 may be installed on a front surface of the cabinet 100 that is hingedly coupled on one side to open or close the cooking chamber 30. The door 10 may shield the front surface of the cooking chamber 30 with the front open. A tray (not shown) on which a food to be cooked may be placed may be provided inside the cooking chamber 30, and a motor may be installed on a lower portion of the tray to cause the food to be cooked to rotate together with the tray.

The front surface of the cabinet 100 may be coupled to a control panel 20 that allows a user to select the intensity or operating time of the microwave depending on the amount of food to be cooked.

In an example, the control panel 20 may be positioned on a rear side of the door 10 such that the control panel 20 is covered by the door 10 when the door 10 is closed, but is not limited thereto. The control panel 20 may be arranged next to the door 10 such that the control panel 20 may be exposed to the outside even when the door 10 is closed.

In an example, the control panel 20 may be configured as a touch screen.

In an example, the control panel 20 may be arranged on the door 10 to move together with the door 10 and form at least a portion of the exterior of the door 10.

The cabinet 100 may be provided with a hood flow path 60 therein through which air containing exhaust gases flowing in through the cabinet inlet 112a flows.

One end of the hood flow path 60 may be arranged to communicate with the cabinet inlet 112a, and the other end of the hood flow path 60 may be arranged to communicate with a cabinet outlet 115 provided in the cabinet 100.

Accordingly, in response to air containing exhaust gases from an outside of the microwave oven 1 flowing in through the cabinet inlet 112a, the air may flow along the hood flow path 60 on the inside of the cabinet 100 and be discharged back to the outside of the microwave oven 1 through the cabinet outlet 115.

A position of the cabinet outlet 115 is not limited, and in an example, the cabinet outlet 115 may be connected to an additional duct running from the inside where the microwave oven 1 is located to the outside.

The microwave oven 1 may include the hood fan 70 configured to form an airflow within the hood flow path 60 for a hood function. The hood fan 70 may be installed on the inside of the cabinet 100. The hood fan 70 may be positioned in the hood flow path 60. More particularly, the hood fan 70 may be positioned on the upper space 50 of the hood fan 70, and preferably may be positioned on a rear side of the upper space 50.

The hood fan 70 may include a cross-flow fan or a sirocco fan. However, the present disclosure is not limited thereto, and may include other types of fans.

The hood fan 70 may draw outside air containing exhaust gases generated from the cooking apparatus 3 into the cabinet 100, and blow the drawn-in air through the cabinet outlet 115 such that the drawn-in air may flow through the hood flow path 60 to reach the cabinet outlet 115, thereby allowing the drawn-in air to be discharged back to the outside of the microwave oven 1.

The microwave oven 1 may include a blower duct 61 forming a portion of the hood flow path 60 connecting the hood fan 70 and the cabinet outlet 115. More particularly, the hood flow path 60 arranged within the blower duct 61 may be covered on an upper side by the cabinet cover 111, and the hood flow path 60 arranged within the blower duct 61 may be formed by the blower duct 61 and the upper surface of the cabinet 100. The blower duct 61 may be arranged on the upper space 50.

A filter may be arranged on an inside of the blower duct 61 to filter the air flowing through the hood fan 70. A filter may be arranged on the hood flow path 60.

In the following, the temperature sensor 300, the blower unit 200, and the circulation unit 400 will be described in detail.

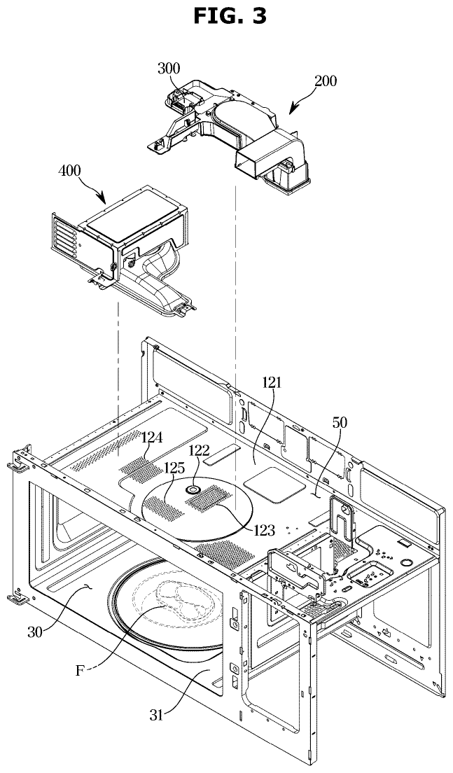

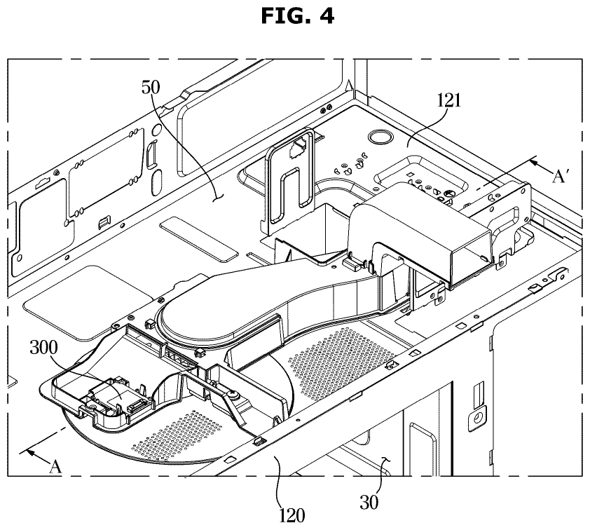

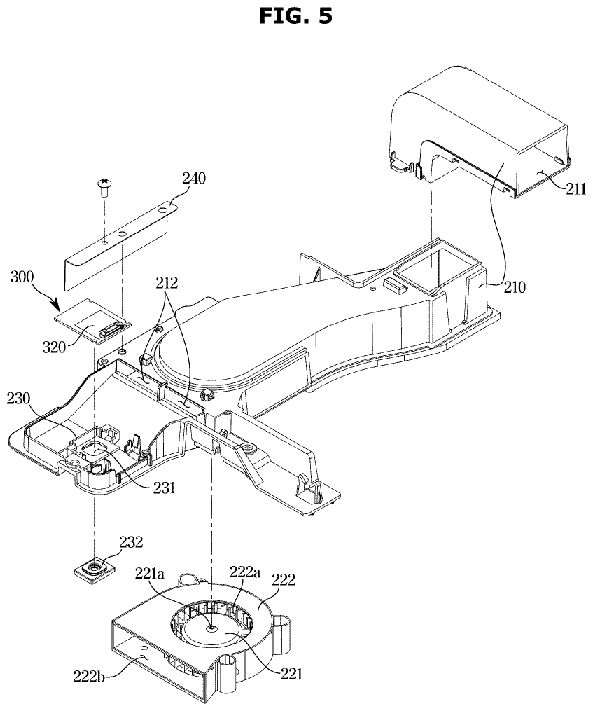

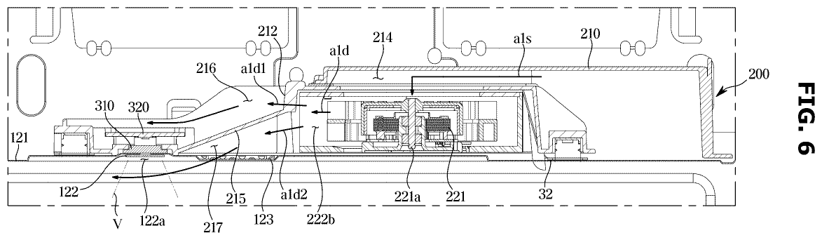

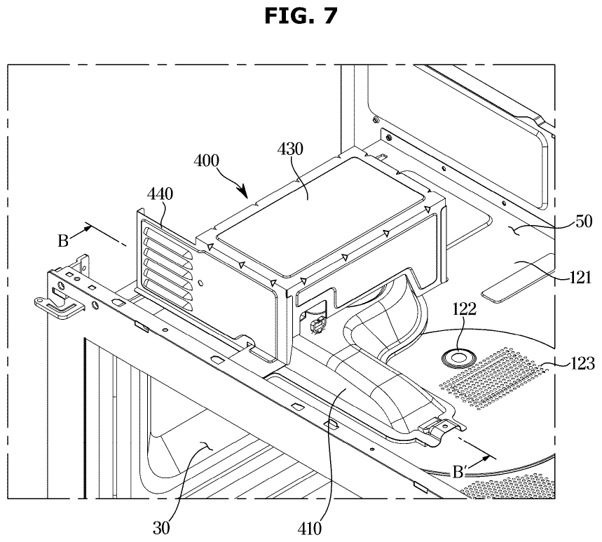

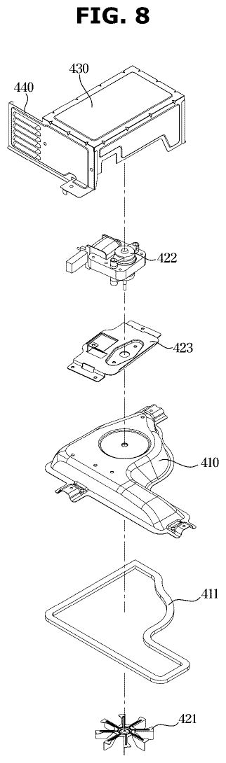

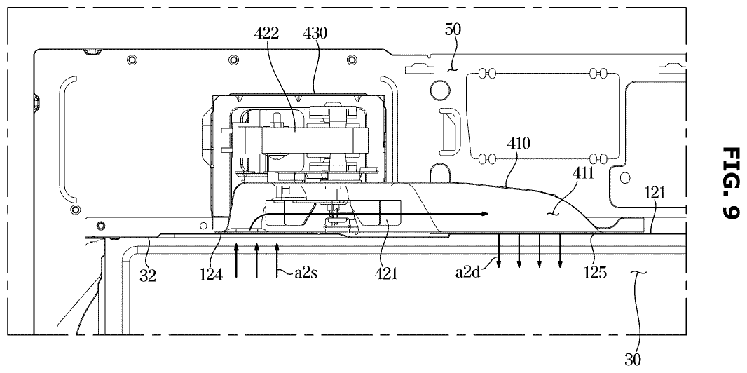

FIG. 3 is an exploded view of some configurations of the microwave oven shown in FIG. 1, FIG. 4 is a view illustrating the temperature sensor and the blower unit of the microwave oven shown in FIG. 1, FIG. 5 is an exploded view of the temperature sensor and the blower unit of the microwave oven shown in FIG. 1, FIG. 6 is a cross-sectional view of the temperature sensor and the blower unit of the microwave oven shown in FIG. 1, FIG. 7 is a view illustrating the circulation unit of the microwave oven shown in FIG. 1, FIG. 8 is an exploded view of the circulation unit of the microwave oven shown in FIG. 1, and FIG. 9 is a cross-sectional view of the circulation unit of the microwave oven shown in FIG. 1.

For the microwave oven 1, the microwave oven 1 may be operated by setting a cooking time based on a predetermined time according to the characteristics of a food to be cooked F in a such a manner that the inside and outside of the food to be cooked F are heated and cooked simultaneously by irradiation with high frequency.

The user may input a cooking time into the microwave oven according to the nature of the food to be cooked and operate the microwave oven for the cooking time. However, since it is difficult to determine the cooking status of the food to be cooked while the microwave oven is operating, the user may only check the cooking status of the food to be cooked after the input cooking time ends. In this case, the food to be cooked may be overcooked or undercooked after the input cooking time has elapsed, which may reduce convenience.

To prevent such a situation, a sensor may be included to detect the temperature of the food to be cooked being cooked inside the cooking chamber. The sensor may measure the surface temperature of the food to be cooked to predict the approximate cooking condition of the food to be cooked, but water vapor water inside the cooking chamber generated by the food to be cooked during cooking may reduce the reliability of the sensor by preventing the sensor from accurately detecting the temperature of the surface of the food to be cooked.

The microwave oven 1 according to an embodiment may include the blower unit 200 to minimize the detection error caused by water vapor when the temperature sensor 300 detects the surface temperature of the food to be cooked F.

The blower unit 200 may be configured to minimize water vapor flowing between the temperature sensor 300 and the food to be cooked F to allow the temperature sensor 300 to accurately detect the surface temperature of the food to be cooked F.

The blower unit 200 may be configured to draw in air from the outside of the cabinet 100 to allow the drawn-in air to flow between the temperature sensor 300 and the food to be cooked F. As a result, the blower unit 200 may remove water vapor from between the temperature sensor 300 and the food to be cooked F together with the flowing air to allow the temperature sensor 300 to accurately detect the surface temperature of the food to be cooked F.

The microwave oven 1 according to an embodiment may include the circulation unit 200 to minimize the detection error caused by water vapor when the temperature sensor 300 detects the surface temperature of the food to be cooked F.

The circulation unit 200 may be configured to minimize water vapor flowing between the temperature sensor 300 and the food to be cooked F to allow the temperature sensor 300 to accurately detect the surface temperature of the food to be cooked F.

The circulation unit 400 may be configured to draw in air from the inside of the cooking chamber 30 and discharge the drawn-in air toward the food to be cooked F. As a result, the circulation unit 400 may cause water vapor around the food to be cooked F to flow to the outside of the food to be cooked F together with the discharged air, so that the temperature sensor 300 may accurately detect the surface temperature of the food to be cooked F.

As shown in FIG. 3, the blower unit 200, the temperature sensor 300, and the circulation unit 400 may all be arranged on the outer upper side of the cooking chamber 30. The blower unit 200, the temperature sensor 300, and the circulation unit 400 may all be arranged in the upper space 50.

In an example, the temperature sensor 300 and the blower unit 200 may be arranged at any location on the outer side of the cooking chamber 30. In other words, the temperature sensor 300 and the blower unit 200 may each be arranged on the outer lower portion or side portion of the cooking chamber 30. The temperature sensor 300 and the blower unit 200 may be arranged in the same outward direction with respect to the cooking chamber 30.

In an example, the circulation unit 400 may be arranged at any location on the outer side of the cooking chamber 30. The circulation unit 400, 30 together with the temperature sensor 300 and the blower unit 200, may be arranged in the same outward direction with respect to the cooking chamber.

The frame 120 may partition the cooking chamber 30 and the upper space 50 in a vertical direction. The frame 120 may include a partition plate 121 that partitions the cooking chamber 30 and the upper space 50 in the vertical direction.

The upper space 50 may be formed on an upper side of the partition plate 121, and the cooking chamber 30 may be formed on a lower side of the partition plate 121. The temperature sensor 300, the blower unit 200, and the circulation unit 400 may be positioned on an upper surface of the partition plate 121. A lower surface of the partition plate 121 may form an upper surface 32 of the cooking chamber 30.

The cooking chamber 30 may include a sensor hole 122 that penetrates the partition plate 121 and through which the temperature sensor 300 is arranged to detect the temperature of the food to be cooked F being cooked in the cooking chamber 30. The sensor hole 122 may be defined as a configuration of the cooking chamber 30, but is not limited thereto. The sensor hole may also be defined as a configuration of the partition plate 121.

A cooking chamber outlet 123, which will be described later, may be formed on the partition plate 12 to allow air blown by the blower unit 200 to flow into the cooking chamber 30. The cooking chamber outlet 123 may be formed in the shape of a hole penetrating the partition plate 121.

A circulation inlet 124 through which air from the cooking chamber 30 is drawn into the circulation unit 400 by the circulation unit 400, and a circulation outlet 125 through which air flowing from the circulation unit 400 flows back into the cooking chamber 30 may be formed on the partition plate 121, as will be described later. The circulation inlet 124 and the circulation outlet 125 may be formed in the shape of a hole penetrating the partition plate 121.

An exhaust port may be formed on the partition plate 121 to allow air or water vapor or the like inside the cooking chamber 30 to escape to the outside.

As shown in FIGS. 4 and 5, the blower unit 200 may be positioned in the upper space 50. The temperature sensor 300 may be positioned in the upper space 50.

The temperature sensor 300 may be attached to a temperature sensor holder 230 of the blower unit 200 and positioned in the upper space 50, but is not limited thereto. The temperature sensor 300 may be positioned in the upper space 50 separately from the blower unit 200. However, since the blower unit 200 and the temperature sensor 300 may each be arranged on the same side of the outer side of the cooking chamber 30 with respect to the cooking chamber 30, they may be arranged to be supported by the blower unit 200.

The blower unit 200 may include a blower fan 221 and a blower duct 210 through which air flows via the blower fan 221.

The blower unit 200 may include a blower fan housing 222 in which the blower fan 221 is arranged to rotate. The blower fan housing 222 may be positioned on the blower duct 210. However, the present disclosure is not limited thereto, and the blower fan housing 222 may be formed integrally with the blower duct 210 as a portion of the blower duct 210.

The blower duct 210 may include an inlet 211 that communicates with the outside of the cooking chamber 30. The inlet 211 may be configured to communicate with the outside of the upper space 50 or the cabinet 100 to allow air from the outside of the cooking chamber 30 to enter the blower duct 210.

Air may be drawn into the blower duct 210 by the blower fan 221, and the drawn-in air may be discharged to the outside of the blower duct 210 via the cooking chamber outlet 123 and an duct outlet 212.

As will be described later, the air discharged from the cooking chamber outlet 123 may be discharged toward a lower portion 122a of the sensor hole 122 and pass through the lower portion 122a of the sensor hole 122, and the air discharged from the duct outlet 212 may flow toward the temperature sensor holder 230 side and exchange heat with the temperature sensor 300.

The blower unit 200 may include the temperature sensor holder 230 on which the temperature sensor 300 is seated.

The temperature sensor holder 230 may be arranged to allow the temperature sensor 300 to be positioned corresponding to the sensor hole 122 in the vertical direction. The temperature sensor holder 230 may include a holder hole 231 positioned between the sensor hole 122 and the temperature sensor 300.

The temperature sensor 230 may detect the surface temperature of the food to be cooked F in the cooking chamber 30 through the holder hole 231 and the sensor hole 122 while seated in the temperature sensor holder 230.

The temperature sensor holder 230 may include a lens cover 232 configured to protect a lens of the camera forming a detection part 310 of the temperature sensor, as will be described later.

The lens cover 232 may be transparent so that the detection part 310 may be transmitted through the lens cover 232 to detect the temperature of the food to be cooked F. The lens cover 232 may be provided with a high heat resistant material so as to be resistant to heat transferred from the sensor hole 122.

The blower unit 200 may include a protective bracket 240 to prevent sparks, flames, and the like generated by configurations forming the blower unit 200 from moving to the hood fan 70 or the electrical chamber 40.

The protective bracket 240 may be arranged on one side of the blower duct 210. Preferably, the protective bracket 240 may be arranged in the blower duct 210 in a direction toward the hood fan 70.

The protective bracket 240 may restrict sparks, flames, and the like generated from the blower fan 221 or the temperature sensor 230, or sparks, flames, and the like generated inside the cooking chamber 30 that have been moved to the blower unit 200 through the cooking chamber outlet 123, from moving to another location.

The blower fan 221 may be provided as a centrifugal fan. The rotation shaft 221a of the blower fan 221 may be arranged to extend in the vertical direction. This may be to minimize the height of the blower unit 200 in the vertical direction by arranging most of the space of the inlet 211 and the blower duct 210 connected from the inlet 211 on an upper side of the blower fan 221.

The blower fan housing 222 may include a housing inlet 222a arranged for air to enter the blower fan 221 and arranged on the upper side of the blower fan housing 222, and a housing outlet 222b arranged for air entering from the housing inlet 222a to exit the blower fan 221 and arranged on a side of the blower fan housing 222 in the vertical direction.

Due to the position of the housing inlet 222a, air flowing in the blower duct 210 may be drawn into the blower fan 221 from the upper side of the blower fan 221 and discharged in a lateral direction of the blower fan 221.

As shown in FIG. 6, the temperature sensor 300 may include the detection part 310 that detects the information of the food to be cooked F being cooked inside the cooking chamber 30 through the sensor hole 122 and a processing part 320 that processes the information detected by the detection part 310.

The detection part 310 may be provided as a thermal imaging sensor that detects the surface temperature of the food to be cooked F. In an example, the detection part 310 may include a thermal imaging camera.

The processing part 320 may be configured to process and store values detected by the thermal imaging camera of the detection part 310. The processing part 320 may include at least one memory for storing data in the form of algorithms or programs for controlling the operation of the detection part 310, and at least one processor for performing operations using the data stored in the at least one memory. The processing part 320 may be implemented in the form of a chip or the like. However, the present disclosure is not limited thereto, and the processing part 320 may simply control the detection part 310 by receiving signals from a controller that controls the microwave oven 1 as a whole.

The detection part 310 may photograph the interior of the cooking chamber 30 through the sensor hole 122 and detect the heat of the food to be cooked F placed inside a field of view V of the detection part 310. When water vapor or the like is present inside the field of view V of the detection part 310, the detection part 310 may not accurately measure the surface temperature of the food to be cooked F. To prevent such a situation, the blower unit 200 may be arranged to remove the water vapor remaining in the field of view V of the detection part 310 with a flow of air, so that the detection part 310 may clearly measure the surface temperature of the food to be cooked F.

The blower duct 210 may include a first flow path 216 configured such that air flowing from the inlet 211 flows through the duct outlet 212 to the processing part 320, and a second flow path 217 configured such that air flowing from the inlet 211 flows between the sensor hole 122 and the food to be cooked F being cooked inside the cooking chamber 30.

The blower duct 210 may include an inflow path 214 having one end connected to the inlet 211 and arranged to allow air from the inlet 211 to flow.

The blower duct 210 may include a partition 215 arranged on the other end of the inflow path 214 and dividing the other end of the inflow path 214 such that the inflow path 214 branches into the first flow path 216 and the second flow path 217.

The inflow path 214 may be connected to the first flow path 216 and the second flow path 217, respectively, and may be divided into the first flow path 216 and the second flow path 217 by the partition 215 within the blower duct 210.

The inflow air a1s flowing in from the inlet 211 may flow along the inflow path 214, and the flow air a1d flowing in the inflow path 214 may be directed to the other end of the inflow path, and by the partition 215, a portion of the air a1d1 may flow through the first flow path 216 and another portion of the air a1d2 may flow through the second flow path 217.

The air a1d2 flowing in the second flow path 217 may pass through the lower portion 122a of the sensor hole 122, thereby forming an air curtain that prevents water vapor generated from the food to be cooked F from entering the sensor hole 122.

The air a1d2 flowing in the second flow path 217 may form an air curtain that prevents heat from advancing to the upper space 50 through the sensor hole 122.

The blower fan 221 may be arranged on the inflow path 214, and may be arranged such that the air a1d blown by the blower fan 221 flows to the partition 215 through the housing outlet 222b.

The air a1d flowing into the partition 215 may be guided by the partition 215 to flow into the first flow path 216 or the second flow path 217.

The first flow path 216 may be guided by the upper surface of the partition 215 to flow to the processing part 320 and cool the heat generated in the processing part 320. The air a1d1 flowing in the first flow path 216 may contact the processing part 320 while flowing in the first flow path 216 and exchange heat with the processing part 320.

The first flow path 216 may be arranged to be connected to the upper space 50 from the inflow path 214 through the duct outlet 212. The first flow path 216 may be formed by the duct outlet 212, the upper surface of the partition 215, and at least a portion of the outer surface of the blower duct 210, and a portion of the first flow path 216 may be arranged to be open from the upper space 50. However, without being limited thereto, the first flow path 216 may be provided within the blower duct 210 and the duct outlet may be arranged adjacent to the processing part 320, so that air may be discharged from the blower duct 210 and in contact with the processing part 320.

The second flow path 217 may be arranged on the lower side of the first flow path 216 and may be connected to the inside of the cooking chamber 30 through the cooking chamber outlet 123.

The second flow path 217 may be formed by the lower surface of the partition 215, at least a portion of the inner surface of the blower duct 210, and the partition plate 121. The cooking chamber outlet 123 may be arranged on the region of the partition plate 121 forming the second flow path 217, so that the air a1d2 flowing in the second flow path 217 may be discharged into the cooking chamber 30 through the cooking chamber outlet 123. However, the present disclosure is not limited thereto, and the second flow path 217 may be arranged so as to be directly connected to the cooking chamber outlet 123 within the air duct 210, so that air flowing through the air duct 210 may flow directly into the cooking chamber outlet 123.

Due to the water vapor generated in the food to be cooked F as the food to be cooked F is heated, the detection part 310 may detect the temperature of the water vapor as the water vapor obscures the field of view V of the camera instead of detecting the food to be cooked F, and thus a result value that is completely different from the temperature of the food to be cooked F may be processed by the processing part 320.

However, the air a1d2 flowing through the second flow path 217 may flow together with the water vapor remaining inside the field of view V of the detection part 310 while passing through the lower portion 122a of the sensor hole 122 from the cooking chamber outlet 123, thereby preventing the residual water vapor from touching the camera surface of the detection part 310 or the heat of the cooking chamber 30 from being directly transferred to the camera.

In other words, the blower unit 200 may remove the water vapor generated in the food to be cooked F from the field of view V of the camera of the detection part 310, and prevent the heat of the cooking chamber 30 from being transferred to the surface of the camera while preventing the formation of steam on the surface of the camera of the detection part 310.

At the same time, the blower unit 200 may be configured to supply air from the outside of the cooking chamber 30 to the processing part 320 to dissipate the heat generated in the processing part 320.

The blower unit 200 may be arranged such that the air drawn in from the inlet 211 flows in independent flow paths through the partition 215, i.e., the first flow path 216 is arranged to flow into the upper space 50 and the second flow path 217 is arranged to flow into the inside of the cooking chamber 30, so that the heat dissipation of the processing part 320 and the formation of the air curtain at the lower portion of the sensor hole 122 may be achieved by the one blower fan 221.

As shown in FIGS. 7 and 8, the circulation unit 400 may be arranged on the upper space 50.

The circulation unit 400 may include a circulation duct 410 through which air drawn in from the cooking chamber 30 flows so as to circulate the air inside the cooking chamber 30, and a circulation fan 421 arranged within the circulation duct 410 and configured to circulate the air inside the cooking chamber 30.

An upper portion of the circulation duct 410 may be provided with a drive motor 422 configured to drive the circulation fan 421 and a fastener 423 for securing the drive motor 422 to the upper portion of the circulation duct 410.

The circulation unit 400 may circulate the air inside the cooking chamber 30, and thus the air entering the circulation duct 410 may contain water vapor and oil vapor. Accordingly, the drive motor 422 may be arranged to be positioned on the outer side of the circulation duct 410.

The circulation unit 400 may include a sealing member 411 arranged between the circulation duct 410 and the partition plate 121 and configured to seal the circulation duct 410. This is because the air entering the duct 410 may contain water vapor and oil vapor, requiring a seal between the circulation duct 410 and the partition plate 121.

The circulation unit 400 may include a cover member 430 configured to cover the drive motor 422 positioned at the upper portion of the circulation duct 410. This may be to protect the drive motor 422 from outside air, as contaminated air generated by other cooking apparatuses 3 may be introduced into the upper space 50 by the hood fan 70.

The circulation unit 400 may include a protective bracket 440 configured to prevent sparks, flames, and the like, that may be generated from the configurations forming the circulation unit 400 from moving to the hood fan 70 or the electrical chamber 40.

The protective bracket 440 may extend from one side of the cover member 430. However, the present disclosure is not limited thereto, and the protective bracket 440 may be arranged on any side of the circulation unit 400 as a configuration separate from the cover member 430.

The protective bracket 440 may restrict sparks, flames, and the like generated from the drive motor 422 or the like, or sparks, flames, and the like generated inside the cooking chamber 30 that have been moved to the circulation unit 400 through the circulation inlet 124 and the circulation outlet 125, from moving to another location. The protective bracket 440 may also restrict the movement of sparks, flames, and the like generated inside the cooking chamber 30 to another location through an exhaust hole that connects to the cooking chamber 30 formed adjacent to the circulation unit 400.

As shown in FIG. 9, the circulation duct 410 may include a circulation flow path 411 through which air introduced from the cooking chamber 30 flows. The circulation flow path 411 can be formed by the upper surface of the partition plate 121 and the inner surface of the circulation duct 410.

One end of the circulation flow path 411 may be provided as a circulation inlet 124 through which the air inside the cooking chamber 30 is introduced, and the other end of the circulation flow path 411 may be provided as a circulation outlet 125.

By the circulation unit 400, a portion of the air a2s inside the cooking chamber 30 may be introduced into the circulation inlet 124 and passed through the circulation fan 421 to form a discharge airflow a2d through the circulation outlet 125.

The circulation outlet 125 may be arranged to face the food to be cooked F inside the cooking chamber 30. Accordingly, the discharge airflow a2d flowing through the circulation outlet 125 may flow toward the food to be cooked F, and accordingly, the water vapor remaining between the circulation outlet 125 and the food to be cooked F may flow together with the discharge airflow a2d.

The circulation outlet 125 may be arranged adjacent to the sensor hole 122. Accordingly, the air discharged through the circulation outlet 125 may flow inside the field of view V of the detection part 310, causing the water vapor remaining inside the field of view V of the detection part 310 to flow outside the field of view V of the detection part 310.

The circulation outlet 125 may be arranged closer to the sensor hole 122 than the circulation inlet 124. Accordingly, the air inside the cooking chamber 30 may flow toward a side away from the field of view V of the detection part 310. In other words, the air inside the cooking chamber 30 may be draw into the circulation inlet 124 and discharged through the circulation outlet 125 to flow inside the field of view V of the detection part 310, thereby causing the water vapor remaining inside the field of view V of the detection part 310 to flow outside the field of view V of the detection part 310.

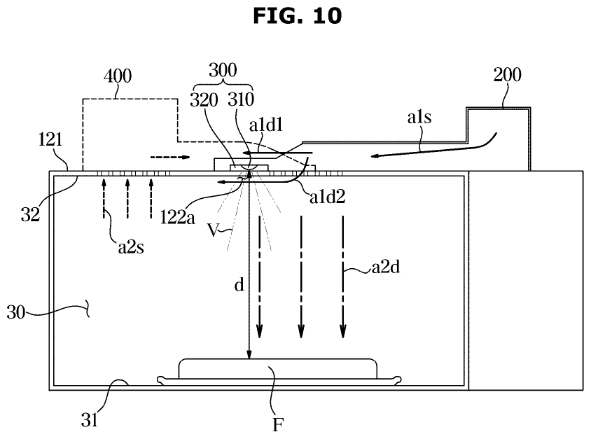

As shown in FIG. 10, the circulation unit 400 may be arranged to draw in a portion of the air a2s inside the cooking chamber 30 and form the discharge air flow a2d in an area adjacent to the sensor hole 122 so that the air circulated inside the cooking chamber 30 flows between d the food to be cooked F and the sensor hole 122.

Accordingly, the discharge airflow a2d may flow toward the food to be cooked F to disperse water vapor, oil vapor, and the like generated by the heating of the food to be cooked F to the outside of the field of view V of the detection part 310.

In addition, the blower unit 200 may be configured to cause air from outside the cooking chamber 30 to be drawn in and flow inside the blower unit 200, to cause a portion of the air a1d1 of the air a1s flowing inside the blower unit 200 to flow to the processing part 320 through the first flow path to exchange heat with the processing part 320, and to cause another portion of the air a1d2 to pass through the lower portion 122a of the sensor hole 122 to form an air curtain at the lower portion 122a of the sensor hole 122, thereby improving the imaging reliability of the detection part 310.

The blower unit 200 and the circulation unit 400 may be configured to measure the temperature of the food to be cooked F in real time while the microwave oven 1 is being operated. Accordingly, the controller of the microwave oven 1 may determine an appropriate cooking temperature of the surface of the food to be cooked F based on a value obtained by inputting or identifying of the type of the food to be cooked F, and in response to the appropriate cooking temperature not being reached while the microwave oven 1 is being operated, control the microwave oven 1 so that the microwave oven 1 is operated for a longer time than the cooking time inputted by the user or the cooking time determined by the controller.

Furthermore, in response to the surface temperature of the food to be cooked F reaching the appropriate cooking temperature before the operation of the microwave oven 1 is terminated, the controller may control the microwave oven 1 to terminate the operation of the microwave oven 1 without user input.

As such, to allow the temperature sensor 300 having a thermal imaging camera capable of measuring the temperature of the food to be cooked F in real time to provide accurate cooking results of the food to be cooked F, the microwave oven 1 may include the blower unit 200 and the circulation unit 400 to remove water vapor generated from the food to be cooked F and to prevent high heat transferred to the temperature sensor 300 and water vapor formation on the camera surface.

Hereinafter, the microwave oven 1 according to an embodiment of the present disclosure will be described. Configurations described below, except for a blower unit 500, will be omitted as redundant to the microwave oven 1 described above.

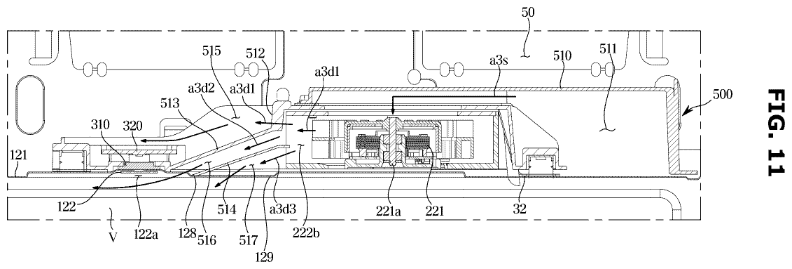

FIG. 11 is a cross-sectional view of a temperature sensor and a blower unit of a microwave oven according to an embodiment.

A blower duct 510 may include a first flow path 515 configured such that air flowing from an inlet flows to the processing part 320 through a duct outlet 512, a second flow path 516 configured such that air flowing from the inlet flows between the sensor hole 122 and the food to be cooked F to be cooked inside the cooking chamber 30, and a third flow path 517 configured such that air flowing from the inlet flows toward the food to be cooked F.

The blower duct 510 may include a first partition 513 arranged at the other end of an inflow path 511 and dividing the other end of the inflow path 511 so that the inflow path 511 branches into the first flow path 515 and the second flow path 516. The blower duct 510 may include a second partition 514 arranged at a lower end of the first partition 513 and dividing the other end of the inflow path 511 so that the inflow path 511 branches into the second flow path 516 and the third flow path 517.

The inflow path 511 may be connected to the first flow path 515, the second flow path 516, and the third flow path 517, respectively, and may be divided within the blower duct 510 by the first partition 513 and the second partition 514 into the first flow path 515, the second flow path 516, and the third flow path 517.

The inflow air a3s may flow along the inflow path 511, and the flow air a3d flowing in the inflow path 511 may be directed to the other end of the inflow path, and by the first partition 513, a portion of the air a3dl may flow through the first flow path 515 and a portion of the air a3d2 may flow through the second flow path 516, and by the second partition 514, another portion of the air a3d3 may flow through the third flow path 517.

The air a3d2 flowing in the second flow path 516 may pass through the lower portion 122a of the sensor hole 122, thereby forming an air curtain that prevents water vapor generated from the food to be cooked F from entering the sensor hole 122.

The air a3d3 flowing in the third flow path 517 may be discharged toward the food to be cooked F to remove the water vapor remaining between the sensor hole 122 and the food to be cooked F.

The first flow path 515 may be guided by an upper surface of the first partition 513 to flow to the processing part 320 and cool the heat generated in the processing part 320. The air a3d1 flowing in the first flow path 515 may contact the processing part 320 while flowing in the first flow path 515 and exchange heat with the processing part 320.

The first flow path 515 may be arranged to be connected to the upper space 50 from the inflow path 511 through the duct outlet 512. The first flow path 515 may be formed by the duct outlet 512, the upper surface of the partition 215, and at least a portion of the outer surface of the air duct 210, and a portion of the first flow path 216 may be provided to be open from the upper space 50.

The second flow path 516 may be arranged on the lower side of the first flow path 515 and may be connected to the inside of the cooking chamber 30 through the cooking chamber outlet 123.

The second flow path 516 may be formed by the lower surface of the first partition 513, the upper surface of the second partition 514, at least a portion of the inner surface of the air duct 510, and a first cooking chamber outlet 128.

The third flow path 517 may be arranged on the lower side of the second flow path 516 and may be connected to the inside of the cooking chamber 30 through a second cooking chamber outlet 129.

The third flow path 517 may be formed by the lower surface of the second partition 514, the upper surface of the partition plate 121, and at least a portion of the inner surface of the blower duct 510.

The air a3d3 discharged through the third flow path 517 may be discharged directly to the food to be cooked F, and thus, the microwave oven 1 according to an embodiment may be reliably operate the temperature sensor 300 without the circulation unit 400 described above.

While the present disclosure has been particularly described with reference to exemplary embodiments, it should be understood by those of skilled in the art that various changes in form and details may be made without departing from the spirit and scope of the present disclosure.

1. A cooking apparatus comprising:
a cabinet;
a cooking chamber inside the cabinet and in which a food to be heated is placeable, wherein the cooking chamber includes a sensor hole;
a temperature sensor outside the cooking chamber and configured to detect, through the sensor hole, a temperature of the food placed inside the cooking chamber, wherein the temperature sensor includes:
a detection part configured to detect information about the food through the sensor hole, and
a processing part configured to perform processing based on the information detected by the detection part;
a blower unit configured to draw in air from outside the cooking chamber, wherein the blower unit includes:
a first flow path along which a first portion of the drawn-in air is flowable to the processing part to remove heat generated by the processing part from the processing part, and
a second flow path along which a second portion of the drawn-in air is flowable between the sensor hole and the food placed inside the cooking chamber so that, with the food placed inside the cooking chamber being heated and the second portion of the drawn-in air being flowed along the second flow path, the second portion of the drawn-in air prevents water vapor generated from the food to be cooked from entering the sensor hole.

2. The cooking apparatus of claim 1, wherein
the temperature sensor is in an outer upper space of the cooking chamber,
the sensor hole is through an upper surface of the cooking chamber, and
the blower unit is further configured so that, with the second portion of the drawn-in air being flowed along the second flow path, the second portion of the drawn-in air passes through a lower end of the sensor hole.

3. The cooking apparatus of claim 2, wherein
the blower unit further includes:
a blower fan configured to draw in the air, and
a duct through which the air drawn in by the blower fan is flowable and which forms the first flow path and the second flow path, and
the duct includes:
an inlet configured to allow the air from outside the cooking chamber to be drawn in by the blower fan,
an inflow path having one end connected to the inlet and configured to allow the drawn-in air to flow therealong, and
a partition at an other end of the inflow path and configured to divide the other end of the inflow path into the first flow path and the second flow path.

4. The cooking apparatus of claim 3, wherein
the blower fan is on the inflow path,
the first flow path is connected from the inflow path to the outer upper space of the cooking chamber, and
the second flow path is below the first flow path and connected to an inside of the cooking chamber.

5. The cooking apparatus of claim 4, wherein
the blower fan is a centrifugal fan having a rotation shaft extending in a vertical direction,
the inflow path is configured so that, with the air from outside the cooking chamber being drawn in, the drawn-in air is introduced to the centrifugal fan from an upper side of the centrifugal fan, and
the first flow path and the second flow path each extend in a radial direction of the blower fan.

6. The cooking apparatus of claim 1, wherein the blower unit further includes a third flow path along which a third portion of the drawn-in air is flowable toward the cooking chamber so that, with the food placed inside the cooking chamber and the third portion of the drawn-in air being flowed along the third flow path, the third portion of the drain-in air flows toward the food.

7. The cooking apparatus of claim 1, further comprising:
a circulation unit configured to draw in air from inside the cooking chamber and to flow the air drawn-in from inside the cooking chamber back to inside the cooking chamber.

8. The cooking apparatus of claim 7, wherein
the circulation unit includes:
a circulation fan configured to draw in the air from inside the cooking chamber,
a circulation inlet configured to allow the air from inside the cooking chamber to be drawn in by the circulation fan,
a circulation outlet configured to allow the air drawn in by the circulation fan to flow back to inside the cooking chamber, and
a circulation duct configured to allow the air drawn in from the circulation inlet to flow to the circulation outlet.

9. The cooking apparatus of claim 8, wherein the circulation outlet is closer to the sensor hole than the circulation inlet.

10. The cooking apparatus of claim 1, further comprising:
a hood fan configured to draw in air from a lower outer side of the cabinet.

11. The cooking apparatus of claim 10, wherein the blower unit, the temperature sensor, and the hood fan are in an outer upper space of the cooking chamber.

12. The cooking apparatus of claim 11, further comprising:
a circulation unit in the outer upper space of the cooking chamber, wherein the circulation unit is configured to draw in air from inside the cooking chamber and to flow the air drawn-in from inside the cooking chamber back to inside the cooking chamber.

13. The cooking apparatus of claim 1, wherein the detection part includes a thermal imaging camera.

14. The cooking apparatus of claim 1, wherein
the blower unit further includes:
a mounting portion on which a sensing unit is mounted, and
a cover bracket on one side of the mounting portion and covering at least a portion of the sensing unit.

15. The cooking apparatus of claim 8, wherein
the circulation unit further includes:
a circulation fan cover covering the circulation fan, and
a cover flange extending from one side of the circulation fan cover.
